(19) United States
(12) Patent Application Publication
(10) Pub. No.: US 2026/0030996 A1
(43) Pub. Date: Jan. 29, 2026

(54) EXPERT-BASED GUIDANCE THROUGH VIRTUAL AVATARS IN AUGMENTED REALITY AND VIRTUAL REALITY ENVIRONMENTS

(71) Applicant: Siemens Industry Software Inc., Plano, TX (US)

(72) Inventors: Mohsen Rezayat, Cincinnati, OH (US); Mehdi Hamadou, Erlangen (DE)

(73) Assignee: Siemens Industry Software Inc., Plano, TX (US)

(21) Appl. No.: 19/150,019

(22) PCT Filed: Feb. 23, 2023
(86) PCT No.: PCT/US2023/013706

§ 371 Date: Jul. 22, 2025

(51) Int. Cl. G09B 19/00

(52) U.S. Cl. CPC G09B 19/003

(57) ABSTRACT

A system may include a semantic actions database configured to reference a working context knowledge graph to specify target actions to perform a task and environment conditions of an environment in which an individual performs the task. The system may also include an expert avatar engine configured to access a posture set from a digital data stream of a target individual performing the task in an environment, classify the postures of the posture set into discrete actions, retrieve target actions from the semantic actions database for performing the task in the environment, generate guidance for the target individual based on a comparison between the discrete actions classified for the target individual and the target actions retrieved from the semantic actions database, and provide the guidance to the target individual to assist the target individual in performing the task.

### BACKGROUND

Computer systems can be used to create, use, and manage data for nearly any type of process or purpose. Virtual reality (VR) and augmented reality (AR) technologies allow users to access and use data in increasingly complex ways, and in increasingly digital environments. AR and VR users can benefit from increased capabilities and resources in AR and VR environments.

### BRIEF DESCRIPTION OF THE DRAWINGS

Certain examples are described in the following detailed description and in reference to the drawings.

FIG. 1 shows an example of system that supports expert-based guidance through virtual avatars in AR and VR environments.

FIG. 2 shows an example capture of expert knowledge in support of expert-based guidance according to the present disclosure.

FIG. 3 shows another example capture of expert knowledge in support of expert-based guidance according to the present disclosure.

FIG. 4 shows an example provision of expert-based guidance for an individual performing a task in an environment according to the present disclosure.

FIG. 5 shows an example of logic a system may implement to support expert-based guidance in AR and VR environments.

FIG. 6 shows an example of a computing system that supports expert-based guidance in AR and VR environments.

### DETAILED DESCRIPTION

With modern technological advances, the viability and adoption of AR and VR technologies is continually increasing. Through overlay of digital data in a physical environment (e.g., through an AR device), AR technologies provide users with increased accessibility to data gathering, analysis, and display capabilities overlaid on a real-world, physical setting. VR technologies can support virtual gatherings to work together in a common virtual site, allowing for training, problem-solving, and greater collaboration amongst users separated across vastly disparate geographical locations, time zones, and physical settings. Virtual universes are being created and populated, allowing users to gather virtually in nearly any type of setting to train, learn, collaborate, and perform complex tasks in virtual gatherings.

With increased capabilities provided by AR and VR technologies, offering assistance to users for performing tasks is increasingly viable. Such guidance may be especially relevant for assisting users in performing complex tasks in different environments. Virtual environments may be especially amenable to performing complex industrial tasks, for example allowing users to first train virtually to operate industrial machinery or perform complex tasks in a virtual setting before endeavoring to perform such tasks in a physical environment. Conventional forms of user assistance for performing complex tasks may be in the form of training videos, for example recording a demonstration of performing the task or through instructional videos and training slides. However, such modes of training provide little feedback or real-time guidance for an individual performing the task, oftentimes in a different setting or with varying environment conditions than the recorded video.

Digital assistants provide another form of assistance to users in performing tasks. Some forms of digital assistants can incorporate artificial intelligence (AI) learning techniques in order to predict feedback to provide a user based on user interactions. Continued research in AI-based chatbots, virtual assistants, and AI avatars can yield improved user interaction in virtual settings with AI-trained virtual beings. However, AI-based training can require immense amounts of training data to function effectively, and at best offer a learned prediction for user assistance instead of actual guidance (e.g., demonstration) from experts in a given field or experts trained to perform specific tasks.

The disclosure herein may provide systems, methods, devices, and logic for expert-based guidance in AR and VR environments. At a high level, the expert-based guidance technology of the present disclosure may provide capabilities to capture and transfer knowledge and actions of an expert to another individual to perform specific tasks. As used herein, an expert may refer to any individual with a threshold level of experience, knowledge, or expertise to perform a task. Thus, capturing and transferring the know-how of experts to less experienced users can provide directly relevant guidance to individuals performing the task, whether in an AR or VR setting. As described herein, expert-based guidance may be provided through virtual avatars, which may refer to any digital or virtual representation of a person, entity, logic, agent, or being. Virtual avatars may be controlled, rendered, and driven by the expert-based guidance technology of the present disclosure, and may thus represent the expert-based guidance technology of the present disclosure (in contrast to virtual avatars representing human experts). Put another way, the virtual avatars described herein may represent digital assistance agents generated and controlled through the expert-based guidance technology of the present disclosure. Virtual avatars of the present disclosure (including their underlying expert-based guidance technology) can be easily replicated and readily available across all types of settings and environments to provide support for users. The replicable virtual avatars of the present disclosure can thus provide expert support without the spatial or time limitations that constrict the availability of human experts located in fixed geographic locations and with limited time availabilities.

In contrast to AI-based virtual assistant technology which attempts to guess user interactions and predict relevant feedback, the expert-based guidance technology of the present disclosure can semantically classify user movements, actions, environment conditions, and any other relevant factor for task performance in order to exactly interpret user actions and generate guidance accordingly. Along similar lines, the present disclosure contemplates the capture and classification of the precise movement and actions of experts in performing the task, allowing for a direct comparison between target actions (e.g., as captured for an expert) and the actual actions performed by a user in an AR or VR environment. Moreover, actions performed by an expert and a user can be augmented with the working context of user and expert actions, allowing for a fuller comparison to provide expert-based guidance for users with increased relevance and effectiveness. Working contexts can be captured through knowledge graphs, which can support dissemination of relevant guidance even when deviations in the working context and environment conditions are present in user environments.

The expert-based guidance technology of the present disclosure may support virtual 3D avatars that can provide relevant expert-based guidance to any individual performing any task of any type or complexity. The expert-based guidance provided by the present disclosure can take many forms, from verbal guidance (e.g., via natural language interfaces) to demonstrations by the virtual avatar to perform steps in complex tasks, and more. These and other expert-based guidance features and technical benefits are described in greater detail herein.

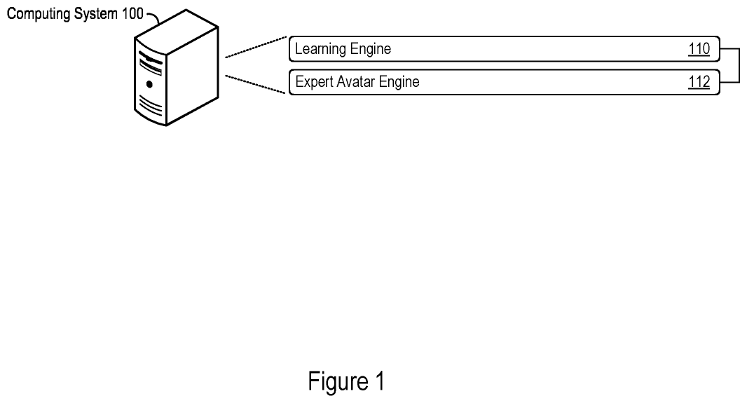

FIG. 1 shows an example of a computing system 100 that supports expert-based guidance in AR and VR environments. The computing system 100 may take the form of a single or multiple computing devices such as application servers, compute nodes, desktop or laptop computers, smart phones or other mobile devices, tablet devices, embedded controllers, and any relevant or applicable technological device. In some implementations, the computing system 100 hosts, supports, executes, or implements a digital assistant system that can implement any of the various features described herein, including the construction and use of 3D digital assistants as virtual avatars in VR and AR environments that can provide expert-based guidance according to the present disclosure.

As an example implementation to support any combination of the expert-based guidance features described herein, the computing system 100 shown in FIG. 1 includes a learning engine 110 and an expert avatar engine 112. The computing system 100 may implement the engines 110 and 112 (including components thereof) in various ways, for example as hardware and programming. The programming for the engines 110 and 112 may take the form of processor-executable instructions stored on a non-transitory machine-readable storage medium and the hardware for the engines 110 and 112 may include a processor to execute those instructions. A processor may take the form of single processor or multi-processor systems, and in some examples, the computing system 100 implements multiple engines using the same computing system features or hardware components (e.g., a common processor or a common storage medium).

In operation, the learning engine 110 may capture expert knowledge of an expert individual performing a given task. The learning engine 110 may do so in any of the various ways described herein, for example by determining a set of actions the expert individual to perform the task, storing the set of actions as target actions for the task in a semantics actions database, and inserting actions of the set of actions, environment conditions for the set of actions, or combinations of both as entries in the working context knowledge graph. As described herein, the semantic actions database may be configured to reference a working context knowledge graph to specify the target actions based on the task and environment conditions of the environment in which an individual (e.g., the expert or an AR or VR user) performs the task.

In operation, the expert avatar engine 112 may access a posture set from a digital data stream of a target individual performing a task in an environment, wherein postures of the posture set are represented through joint locations of the target individual (e.g., body joints), classify the postures of the posture set into discrete actions, retrieve target actions from a semantic actions database for performing the task in the environment, and generate guidance for the target individual based on a comparison between the discrete actions classified for the target individual and the target actions retrieved from the semantic actions database. The expert avatar engine 112 may further provide the guidance to the target individual to assist the target individual in performing the task, for example in the form of a virtual 3D avatar in an AR or VR environment, doing so in any of the ways described herein.

These and other expert-based guidance features and technical benefits are described in greater detail next. Many of the examples and description provided herein are explained as specific to a particular task that an individual performs. As such, the expert-based guidance technology of the present disclosure can be implemented to support and assist performance of individual tasks, and a task may refer to any piece of work to perform. In industrial contexts, a task can vary in complexity to nearly any degree, from simple tasks like inserting a screw into a threaded opening on a metal frame to complex tasks such as assembling a vehicle engine, and more. The expert-based guidance technology described herein is flexible, in that it can be adapted and applied to tasks of any complexity and difficulty, allowing for broad applicability and expert avatar availability for any type of requirement, task, or project.

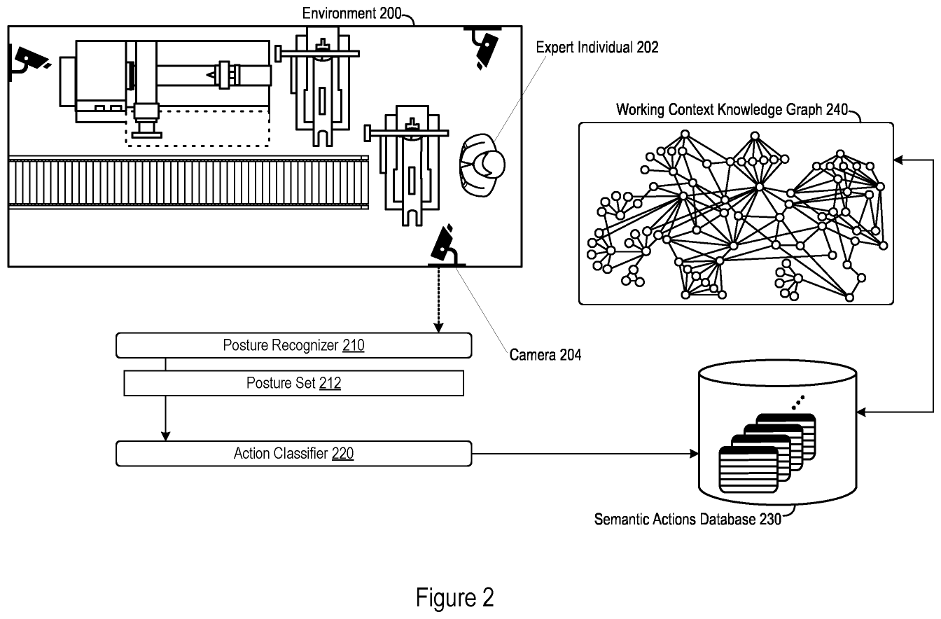

FIG. 2 shows an example capture of expert knowledge in support of expert-based guidance according to the present disclosure. In particular, FIG. 2 provides an illustrative example by which the learning engine 110 can capture expert knowledge for performing a task through observing and analyzing movements of an expert individual in a physical (e.g., non-virtual) environment. In a general sense, the learning engine 110 may process movement data of the expert individual in performing the task to precisely classify and categorize the expert individual's actions in performing the task. Then, the learning engine 110 may semantically classify the expert individual's movement to determine a set of target actions an expert takes to perform the task.

To illustrate through FIG. 2, an environment 200 is shown in which an expert individual 202 performs a task. In the specific example of FIG. 2, the task performed by the expert individual 202 comprises operating a manufacturing device in a manufacturing line of a factory, though any suitable task is contemplated herein. As noted herein, an expert, such as the expert individual 202, may refer to any person that includes or possesses a threshold amount of knowledge, experience, or capability to perform a given task. Such thresholds may be configured or measured in any relevant or meaningful manner. The expert may be a person with a certain amount of work experience in a particular field, with specific educational requirements, with specific familiarity of a given process or workflow, or as otherwise designated by any suitable entity (e.g., corporation, certification board, industry panel, etc.). Accordingly, experts may possess knowledge and “know-how” for performing specific tasks, which can be captured and form a basis by which expert-based guidance can be provided to other individuals performing the specific tasks.

The environment 200 may be a physical environment, e.g., a non-virtual setting such as an actual shop floor or field service location in which the expert individual 202 operates machinery to perform a task. To support expert knowledge capture, the environment 200 may include any number of sensors to capture movement data of the expert individual 202 as the expert individual 202 performs the task. The sensors may take the form of any device that can capture data regarding the actions or movement of the individual expert 202. As an example, the environment 200 shown in FIG. 200 includes cameras, such as the camera 204, to capture movement data of the individual expert 202. The camera 204 may be an RGBD camera that can track additional depth information of the expert individual 202. Video streams of the expert individual 202 can capture movement data of the expert individual 202, and the learning engine 110 can access video streams captured by the camera 204 or other data streams captured by sensors of the environment 200.

Posture recognition technology can be used to process the captured sensor data of the expert individual 202. Posture recognizers can be implemented as software components that can compute body poses of a person according to a kinematics human model, for example based on joints of a human model and links of limbs. In the example of FIG. 2, a posture recognizer can generate a posture set for the expert individual 202 from video data (e.g., video frames) captured by the camera 204. The posture set may specify a sequence of postures of the expert individual 202, for example doing so through joint locations of the expert individual 202 in successively sampled video frames from the camera 204 or other time-sequential sensor data.

For joint recognition and posture computations, a posture recognizer can utilize any number of software libraries or AI-technology, for example deep-learning neural networks such as HRNet, MediaPipe, OpenPose, PoseNet, and more. In some implementations, the learning engine 110 may concatenate or otherwise combine joint recognition technologies with finger tracking technology, as doing so may provide a broader or more complete view of actions of experts in performing tasks. Finger tracking technology may further allow expert-based guidance (e.g., as provided by a virtual 3D avatar) to demonstrate expert actions to AR and VR users with increased effectiveness. Thus, the learning engine 110 may support the generation or access of computed posture sets with finger joint locations.

In any of the ways described herein, the learning engine 110 may access posture sets for an expert individual performing a task. The learning engine 110 may itself implement any suitable posture recognition technology to determine posture sets or otherwise receive posture sets computed by posture recognizers external to (e.g., remote from or logically separate from) the learning engine 110. In the example of FIG. 2, the learning engine 110 accesses the posture set 210 computed from sensor data captured from the expert individual 202 performing a task in the environment 200.

In further support of knowledge capture of the expert individual 202, the learning engine 110 may classify the posture set 210 into discrete actions. A discrete action may refer to any form of categorization of a set of human poses into a finite or semantically atomic classification, referred to herein as actions. Examples of actions may include semantic terms to “stand”, “bend”, “reach”, “walk”, “sit”, “lift”, “push”, “pull”, etc. Within an industrial context for the performance of specific tasks, the learning engine 110 may limit classification to a finite number of actions as many industrial tasks need only require a finite set (e.g., dozens) of actions for satisfactory performance.

Action classifier technology may be implemented as a software component that receives a stream of body poses (e.g., the posture set 210) and classifies the body poses into discrete actions. An example of such a component is shown as the action classifier 220 in FIG. 2. Action classifiers can be implemented through neural network (NN) architectures like long-short term memory (LSTM) networks, transformer NN's, deep NN's, few-shot learning, and the like. The learning engine 110 may itself implement the action classifier 220 (or any suitable action classifier technology) to categorize posture sets. In other implementations, the learning engine 110 may classify posture sets by receiving classified actions from action classifier components external to (e.g., remote from or logically separate from) the learning engine 110.

In some implementations, the learning engine 110 (e.g., through the action classifier 220) may further classify actions as a combination of actions in the posture set. Such combined actions may be specified as a combination of other actions, such as a “stand_reach_overhead” action, which could be a combination of “stand” and “reach” actions. The actions classified by the learning engine 110 may be discrete in that postures (e.g., posture subsets in the posture set 210) can be classified into separate and distinct actions. The sequence of actions classified by the learning engine 110 may form a set of target actions that the expert individual 202 undertakes in order to perform the task. The target actions attributable to the expert individual 202 may precisely define a set (and sequence) of movements to take to perform a task in semantic terms. The actions of such an expert individual 202 may be referred to as “target” actions as they represent an exemplary or model sequence of actions by an expert in order to perform a given task.

The learning engine 110 may use a semantic actions database to store captured expert knowledge for performing a task. In the example shown in FIG. 2, the learning engine 110 may implement or otherwise access a semantic actions database 230. The semantic actions database 230 may store target actions for performing a specific task, and such target actions may be derived from an actual performance of the specific task by an expert individual. Thus, the learning engine 110 may store target actions classified from the posture set 210 of the expert individual 202 performing a task in the environment 200 in the semantic actions database 230. In some implementations, the learning engine 110 may further store the posture set 210 in the semantic actions database 230, and may further link specific subsets of postures to a given action that the subset of postures is classified into.

Note that the semantics action database 230 need not store video data of the expert individual 202 performing the task. Instead, entries in the semantic actions database 230 capture or semantically characterize the movement of the expert individual 202 through classified actions (and, in some implementations, corresponding posture sets) without video data. Thus, the amount of data required to characterize movements of an expert performing a task may be relatively compact (and significantly lesser in size without video data), while nonetheless maintaining sufficient semantic clarity to support guidance generation and provision for other non-expert individuals performing a task.

As yet another example feature, the learning engine 110 may store a working context of the environment 200 in which the expert individual 202 performs the task together with the classified actions for performing the task. The working context of a task performance may refer to any quantifiable aspect of an environment in which an individual performs a task, the task itself, or the individual that performs the task. Thus, the working context of a task performance may be measured and specified in near-limitless ways. By accounting for working context, the learning engine 110 may learn, track, and process various factors that can impact the performing of a task, which can allow for generation of relevant guidance when other (non-expert) individuals different from the expert perform the task in a different environment. Various examples of working context are presented herein.

The working context of a given task may include part data for any parts involved in the task. Dimension values of physical components, structural characteristics, lot numbers, part tolerances, and any other value of part data can be captured by the learning engine 110 as working context for performing a task. In a similar manner, the working context of the given task may include tool data for any tools used to perform the task, such as tool parameters, maintenance schedules, machinery types, and any other quantifiable tool value.

As another example, environment conditions may also be quantified by the learning engine 110 as working context for performance of a given task. Environment conditions can include any characteristics in the environment in which the task is performed, and could thus include part data and tool data. Other environment conditions could include environment temperatures, weather characteristics (e.g., for outdoor environments), pressure levels, humidity, resource consumption levels (e.g., electrical consumption, network bandwidth, memory storage levels, processor utilization rates, etc.), and more. Such environment conditions may be captured through sensor data in environments, such as the environment 200 in which the expert individual 202 performs the task. For virtual environments, environment conditions can be tracked, extracted, or otherwise obtained through software (e.g., through particular parameters, characteristics, and settings of a virtual environment in which a task is performed in VR). As yet another example, any quantifiable aspect of the individual performing the task may be tracked as a working context of performing the task. Such aspects include a height or age of the individual, whether the individual is right-handed or left-handed, or any other aspect of the individual.

While some non-exhaustive examples of working context are presented herein, the working context of a given task may include any aspect related to the task, and the learning engine 110 may track the working context accordingly. The learning engine 110 may track working context for a task through a knowledge graph. A knowledge graph may refer to a graph-structured data model to integrate data. As such, a knowledge graph may specify a collection of interlinked descriptions of entities, objects, relationships, events, abstract concepts, etc. Knowledge graphs can specify a context in which data objects exist through semantics that dictate node linking or semantic metadata. Accordingly, knowledge graphs may be a particularly amenable data structure by which the learning engine 110 can track working contexts of task performances.

The learning engine 110 may construct or otherwise maintain a working context knowledge graph to track the working context of tasks. In the example of FIG. 2, the learning engine 110 maintains the working context knowledge graph 240 and inserts entries (e.g., tuples) into the working context knowledge graph 240 to store context data. Nodes and edges of the working context knowledge graph 240 may be constructed through tuple insertions, with edges specifying a semantic relationship between objects. Through the working context knowledge graph 240, the learning engine 110 may implement a common semantic description and understanding for any aspect of a task and the environment in which the task is performed. In that regard, the working context knowledge graph 240 can generalize expert knowledge and working context data to convey to others. Moreover, the learning engine 110 can leverage the reasoning capabilities of knowledge graphs to learn new relationships in the working context.

In some implementations, the learning engine 110 may link the working context knowledge graph 240 to the semantics action database 230. By doing so, the semantics action database 230 can store or otherwise reference to working context conditions, values, and any relevant aspect in which actions are performed for a given task. Links from the semantics action database 230 to the working context knowledge graph 240 may be implemented by the learning engine 110 as references to specific nodes or edges in the working context knowledge graph 240 from specific target actions in the semantic actions database 230. Such links may provide insight and semantic understanding into the environment conditions, tools, parts, and other relevant context information for specific steps, actions, and movements in performing the task, which may allow for more detailed and relevant guidance for other individuals performing the task.

As described herein, the learning engine 110 may maintain a working context knowledge graph to track any relevant aspects of the working context for performing a task. To maintain a working context knowledge graph, the learning engine 110 may populate or otherwise insert entries into the working context knowledge graph in various ways. For expert knowledge captured through video recordings of tasks performed by expert individuals in physical settings (e.g., as in the example of FIG. 2), the learning engine 110 may extract any relevant working context data from the video stream and insert as corresponding nodes and edges in the working context knowledge graph. For example, depth information between a user and various part or tools may be contained in the video stream (e.g., as captured through an RGBD camera). The learning engine 110 may process the video stream data to determine corresponding depth values and insert such working context data into a working context knowledge graph.

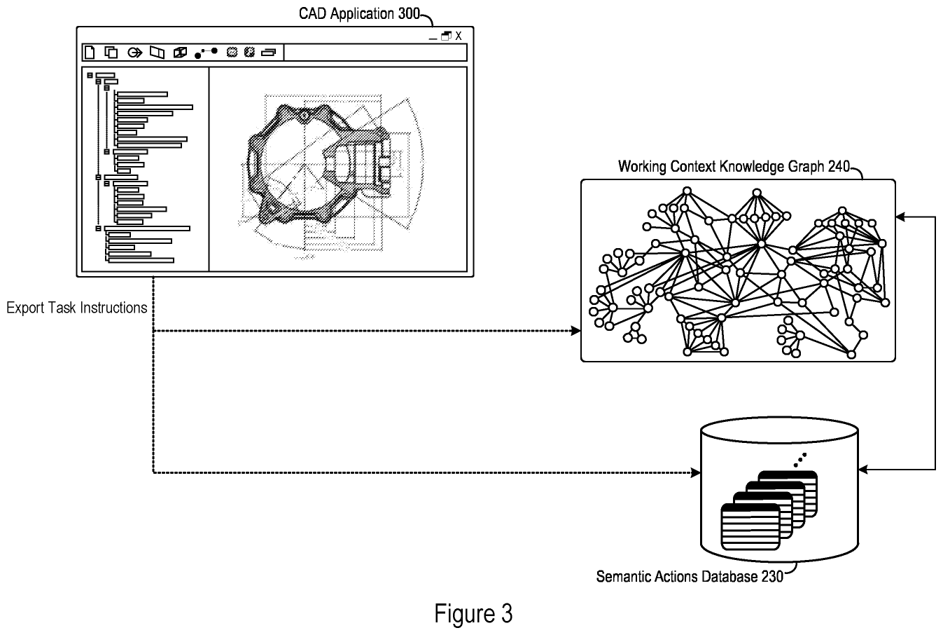

As other examples, the learning engine 110 may expressly insert tuples or relationships, e.g., via input by the expert individual 202 themselves through an I/O interface to the learning engine 110. As yet another example, the learning engine 110 support extraction of engineering data from engineering tools, e.g., computer-aided design (CAD) systems, computer-aided engineering (CAD) tools, computer-aided manufacturing (CAM) applications, product lifecycle management (PLM) systems, or any other engineering system or tool. Example features of expert knowledge capture and working context tracking through engineering tools is described in greater detail next with reference to FIG. 3.

FIG. 3 shows another example capture of expert knowledge in support of expert-based guidance according to the present disclosure. In the example of FIG. 3, the learning engine 110 may capture expert knowledge to store in the semantic actions database 230 and the working context knowledge graph 240. In particular, the learning engine 110 may do so by extracting expert knowledge and context data from engineering tools. Engineering tools, which may include CAD, CAM, CAE, and systems as non-exhaustive examples, may specify various characteristics of parts, products, tools, manufacturing processes, and other relevant data in digital formats. While each respective engineering tool may implement and store data according to a particular (and at times proprietary) data format, the learning engine 110 may support extraction of engineering data from engineering tools into a common semantic and ontological understanding, namely the working context knowledge graph 240.

In the example shown in FIG. 3, the learning engine 110 extracts expert knowledge from a CAD application 300. The CAD application 300 is shown as but one example of engineering tool from which the learning engine 110 may extract data to store in the semantics action database 230 or the working context knowledge graph 240. For example, the learning engine 110 may extract engineering designs (e.g., CAD models) for any relevant part or tool of an environment in which a process is performed. CAD engineering data may include part dimensions, tolerances, material characteristics, and the like. The extracted engineering designs (and underlying engineering data) may then be transformed into tuples supported by knowledge graphs, and thus inserted into the working context knowledge graph 240.

Many modern engineering tools support extraction of engineering data into a semantic format support by knowledge graphs, and the learning engine 110 may leverage any supported or pre-existing data export tools of engineering tools. Additionally or alternatively, the learning engine 110 may apply any data extraction, information processing, and cross-domain link discovery techniques in order to process and insert data from the CAD application 300 into the working context knowledge graph 240.

The learning engine 110 may support extraction of expert knowledge from engineering tools to store into the semantic actions database 230 as well. In some examples, the CAD application 300 or other engineering tools may store or specify instruction sets by which to perform a task. Instruction sets may include any textual or video instruction of an engineering tool, such as instruction manuals to use specific machinery or industrial tools. The learning engine 110 may extract the instruction sets from engineering tools and convert the instruction sets into a semantic format suitable for the semantic actions database 230. In that regard, the learning engine 110 may classify exported instruction sets into discrete actions that fit the semantic framework of target actions stored in the semantic actions database 240. The method by which the learning engine 110 does so may vary based on how instruction sets are stored or provided by the engineering tool.

For text-based instruction sets, the learning engine 110 may parse the text of an instruction set and extract relevant actions by which to perform the instructions. In some sense, the learning engine 110 may translate or convert text of an instruction set (e.g., manual) of an engineering tool into atomic actions of the semantic framework for which the semantic actions database 240 stores actions. Oftentimes, in industrial contexts, the universe of steps to perform tasks are finite, and instruction manuals may thus be translated or converted into semantic actions of the present disclosure with increased efficiency and speed. The learning engine 110 may implement any suitable technology to support such conversions.

As another example, engineering tools can provide virtual instruction videos, for example with virtual persons performing steps of a task as part the instructional video. Such instructional videos or virtual instructions may comprise posture sets and classified actions of the expert performing the task. In such cases, the learning engine 110 may extract a posture set, sequence of actions, or a combination of both from the engineering tool itself.

In other implementations, the learning engine 110 may extract expert knowledge from such engineering tools in a consistent manner as with video data from an expert individual performing the task in a physical environment. Instead of sensor data in the form of a video stream, the learning engine 110 may provide the virtual learning video as an input to a posture recognizer in order to access a posture set for the virtual avatar performing the task in a virtual environment. Processing of a virtual video may be done in a consistent manner as that of processing a video stream of a physical environment, with posture recognition performed for the virtual 3D avatar instead of a human in the video stream. Then, the learning engine 110 may classify the posture set for the virtual 3D avatar of the learning video and store classified actions as target actions in the semantic action database 240. In such cases, the “expert” from which the learning engine 110 captures expert knowledge may be the virtual avatar performing the task virtually in the instruction video. The working context of the virtual instruction video may be exported from the engineering tool as well and stored as data entries in the working context knowledge graph 240.

In any of the ways described herein, a learning engine 110 may capture knowledge of an expert performing a task, and store captured knowledge in a common semantic format. Through knowledge graph technologies, the learning engine 110 may track the working context in which a task is performed by the expert and allow for a fuller understanding of the various environment conditions and individual factors that can contribute to a successful performing of the task. Extraction of instruction sets and working context from engineering tools may provide an additional or alternative mechanism by which the learning engine 110 can populate the working context knowledge graph 240 and the semantics action database 230.

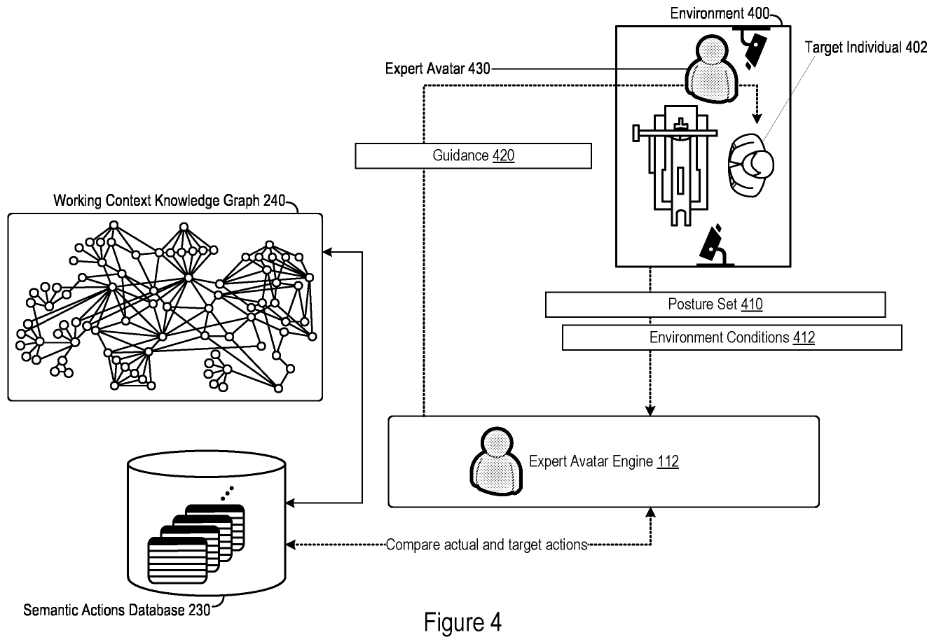

The expert knowledge captured in the semantic actions database, e.g., in the form of a sequence of target actions to perform the task, together with the working context in which the sequence of target actions is performed can provide an exact, yet flexible, definition of a successful performing of the task to which action sequences of other individuals can be compared. Through such a comparison, expert-based guidance can be provided to other individuals attempting to perform the given task, such as through virtual avatars that can interact with these other individuals to verbally guide or provide visible demonstrations. Example features of generation and provision of expert-based guidance using the semantic actions database 230 and working context knowledge graph 240 are described next with reference to FIG. 4.

FIG. 4 shows an example provision of expert-based guidance for an individual performing a task in an environment according to the present disclosure. The example features of FIG. 4 are described using the expert avatar engine 112 as an example, though any implementations consistent with present disclosure are contemplated herein. The expert avatar engine 112 may leverage expert knowledge captured in the semantic actions database 230 and the working context knowledge graph 240 to provide guidance to individuals to perform a given task in a given environment, for example through a virtual 3D avatar.

To illustrate, FIG. 4 includes an environment 400 in which a target individual performs a task. Note that the environment 400 in which the target individual performs the task need not be identical to the environment 200 in which the expert individual 202 of FIG. 2 performs the task. For example, the environment 400 may be a virtual environment of an industrial virtual reality setting, and the target individual 402 may perform the task virtually in the virtual reality setting. There may be any number of variations in environment conditions between the environments 200 and 400, and yet the expert avatar engine 112 may nonetheless provide relevant expert-based guidance. The expert avatar engine 112 may provide guidance in performing the task through a virtual 3D avatar rendered in the virtual reality setting. As another example, the example 400 may be a physical environment in which the target individual 402 performs the task physically, and in which the expert avatar engine 112 may provide guidance through AR technology, e.g., through a virtual 3D avatar overlaid in a view of the target individual 402 through an AR device.

To provide expert-based guidance, the virtual avatar engine 112 may identify and track movement of the target individual 402 performing the task in the environment 400. To do so, the environment 400 may include any number of sensors to capture movement data of the target individual 402. The sensors may comprise any of the sensors described herein with reference to FIG. 2, such as cameras or other sensors. From the movement data of the target individual 402, the expert avatar engine 112 may access a posture set of the target individual 402 performing the task. In that regard, the expert avatar engine 112 may implement or otherwise access posture recognizer technology in any ways as consistently described herein. In the example of FIG. 4, the virtual avatar engine 112 accesses a posture set 410 for the target individual 402 performing the task in the environment 400, and the posture set 410 may be represented through joint locations of the target individual 402 (e.g., including finger joint locations).

The virtual avatar engine 112 may also access environment conditions 412 for the target individual 402 performing the task in the environment 400. The environment conditions 412 may specify any quantifiable aspect of the environment in which the target individual 402 performs the task, and may thus include part dimensions, tool parameters, and any other aspect of the task performance as described herein. The virtual avatar engine 112 may access the environment conditions 412 in a variety of ways. Any suitable sensor may be included in the environment 400 through which the expert avatar engine 112 may access relevant environment conditions, such as temperature, pressure, humidity, resource availability, etc. As an additional or alternative example, the expert avatar engine 112 may support direct input of environment conditions 412 by the target individual 402, e.g., through natural language dialogue with a virtual 3D avatar generated by the expert avatar engine 112 for the environment 400.

The expert avatar engine 112 may itself derive any number of environment conditions for the target individual 402 and the environment 400, for example by processing the posture set 410 to determine if the target individual 402 is performing the task with a particular dominant hand or if the target individual's height or relative positions to other objects in the environment 400. In any of the ways described herein, the expert avatar engine 112 may access a posture set 410 and environment conditions 412 for the target individual 402 performing a task in the environment 400.

In a consistent manner as described herein, the expert avatar engine 112 may classify the postures of the posture set 412 into discrete actions, doing so via action classifier technology as described herein. Then, the expert avatar engine 112 may retrieve target actions from the semantic actions database 420 for performing the task. Through a comparison between the sequence of actions classified for the target individual 402 and the target actions for performing the task captured for an expert individual 202 performing the task, the expert avatar engine 112 may determine deviations from expert performance of the task by the target individual 402 through the action comparison.

The expert avatar engine 112 may compare the sequence of actions of the target individual 402 with the retrieved sequence of target actions of an expert in various ways. In some implementations, the expert avatar engine 112 may synchronize the two sequences of actions based on an initial action sequence detected for the target individual 402, the target actions of the expert individual retrieved from the semantic actions database 230, or a combination of both. For instance, the target actions for an expert performance of the task may start with a particular action sequence such as action₁-action₂-action₃. The expert avatar engine 112 may synchronize the action sequence classified for the target individual 402 upon detection of the sequence action₁-action₂-action₃ for the target individual 402. Any threshold of matching actions or action sub-sequences may be used to synchronize the two action streams for comparison. As another example, the expert avatar engine 112 may synchronize the sequence of actions for the target individual 402 and the retrieved target actions of an expert based on timestamps or through any suitable time-based synchronizations.

In comparing the sequence of actions of the target individual 402 and the target action sequence of an expert, the expert avatar engine 112 may determine any deviation between the two action sequences as a difference between the target individual 402 performing the task and that of the expert's task performance. A deviation may refer to any difference between the sequence of classified actions for the target individual 402 and the sequence of target actions as performed by an expert. The expert avatar engine 112 may take action (e.g., generate guidance) based on a degree of deviation between the two action sequences. For deviations determined as minor deviations without impact on the performance of the task by the target individual 402, the expert avatar engine 112 may take no action. For major deviations that differ between the action sequences, the expert avatar engine 112 may intervene by providing guidance, including at times requesting the target individual 402 cease action.

In some implementations, the expert avatar engine 112 may account for the working contexts for performing the task in determining deviations (and the extent of such deviations) between the sequence of actions of the target individual 402 and the target action sequence of the expert. To do so, the expert avatar engine 112 may query the working context knowledge graph 240 with particular actions performed by the target individual 402 and working conditions 412 for the particular actions. The working context knowledge graph 420 may specify certain constraints, restrictions, or permitted deviations for which the target individual perform the particular action, through which the expert avatar engine 112 may characterize the degree to which any determined deviation between action sequences and/or working context impacts the performing of the task.

The expert avatar engine 112 may classify deviations between action sequences and working context as major and minor according to any number of deviation criteria. In some instances, the deviation criteria may specify certain actions in target action sequences are critical actions, and a major deviation is determined when the action sequence of the target individual 402 deviates from a critical instruction in the target action sequence of the expert. Minor deviations may be characterized by differences in postures of the target individual or minor differences in environment conditions that do not impact the actual performing of the task. For instance, a target individual 402 using their left hand to perform a task whereas a target action by performing the task with their right hand may be characterized as a minor deviation in the action sequences. In some instances, the working context data of the working context knowledge graph 420 can specify criticality measures for context data, and thus queries to the working context knowledge graph 240 can indicate whether a difference for the particular working context data or corresponding action is classified as a major or minor deviation.

The expert avatar engine 112 may generate guidance for the target individual 402 based on a comparison between the discrete actions classified for the target individual 402 and the target actions retrieved from the semantic actions database 240. The comparison by the expert avatar engine 112 may indicate a deviation classification which may indicate a deviation degree and impact on performing the task, e.g., major or minor, on a criticality scale, or according to any suitable and configurable classification scheme.

In some implementations, the expert avatar engine 112 may implement a guidance generator, a component that can drive the feedback and guidance that a virtual 3D avatar can provide to the target individual 402 performing the task. One example of a virtual 3D avatar that the expert avatar engine 112 may render is shown in FIG. 4 as the expert avatar 430, which may be any virtual avatar that the expert avatar engine 112 generates and controls to provide the expert-based guidance features of the present disclosure. For minor deviations (or no deviations at all) in the action sequence or working context, the expert avatar engine 112 need not utilize the guidance generator and determine to provide no guidance to the target individual 402. For major deviations, the expert avatar engine 112 may generate guidance to assist the target individual 402 in performing the task. In some implementations the guidance generator may provide verbal feedback, for example in the form of natural language that the expert avatar engine 112 can provide to the target individual 402.

As another form of guidance, the guidance generator may generate guidance in the form of demonstrations. For example, the expert avatar engine 112 may drive the expert avatar 430 to virtually perform the deviated action for the target individual 402, whether in the virtual environment that the target individual 402 performs the task in or as a virtual overlay in physical environment. By doing so, the expert avatar engine 112 may utilize the joint positions of the posture subset of the deviated action and drive the expert avatar 430 according to the posture subset to demonstrate the deviated action virtually to the target individual 402. Such a form of guidance may be performed in combination with natural language dialogue, and doing so may provide conversational and collaborative experience for the target individual 402. In some implementations, the expert avatar engine 112 may provide such dialogue to relay any relevant or additional information to the target individual 402, and such a feature can be implemented using voice through a text-to-speech (TTS) component, providing a natural interaction environment.

In a consistent manner, the expert avatar 430 provided by the expert avatar engine 112 may answer questions of the target individual 402, which may include querying the working context knowledge graph 240 to provide an answer to any questions that the target individual may ask. In providing guidance, the expert avatar engine 112 may animate or otherwise render the expert avatar 430 in a field of view of the target individual 402, for example through an AR or VR device (e.g., headset). Such rendering of virtual 3D avatars need not require any artificial intelligence to implement, which may reduce the complexity and computational requirements for the expert-based guidance technology of the present disclosure as compared to AI-drive virtual assistants. Moreover, the expert avatar engine 112 may position the rendered expert avatar 430 proximate to the target individual 402 for a more effective knowledge transfer experience with the target individual 402.

Through any of the ways described herein, the expert avatar engine 112 may provide guidance to the target individual 402 to assist the target individual in performing the task. An example of such guidance is shown in FIG. 4 as the guidance 420, which may take the form of textual guidance provided through a voice and TTS capabilities of a virtual 3D avatar, animated performance and demonstration of any actions or sub-steps of performing the task, or any other form of animated guidance by the virtual avatar to assist the target individual 402. Based on the deviation of action sequences, the expert avatar engine 112 may identify a missing part forgotten by the target individual, and the generated guidance may include an identification (e.g., pointing) of the missing part by the virtual 3D avatar. Other forms of animated guidance may direct the target individual in a human-like manner, mimicking the required motion(s) to perform a particular task step at which a deviation occurs, or any other form of suitable assistance to provide to the target individual 402 to perform the task.

In any of the various ways described herein, the expert avatar engine 112 may generate and provide guidance 420 to a target individual 402 performing a task in an environment 400. As described herein, the guidance may be generated based on a direct comparison between a target action sequence of an expert performing the task. Through classified action sequences, the expert avatar engine 112 may have a consistent semantical understanding of the actions performed by the target individual 402 as compared to the target sequence of actions performed by the expert to perform the task. Such a direct comparison along a consistent semantical framework can allow for efficient and accurate comparisons, allowing the expert avatar engine 112 to generate guidance based on actual expert actions (as opposed to predictions like Al-based virtual assistants). Moreover, the working context knowledge graph applied by the expert avatar engine 112 may allow the expert avatar engine 112 to determine whether deviations in actions are minor or major, and tailor generated guidance accordingly.

In some implementations, the expert avatar engine 112 or the learning engine 110 may update the working context knowledge graph 240. As the expert avatar engine 112 provides guidance to multiple different individuals performing the task in different environment with varying working contexts, the expert avatar engine 112 may track the various performed action sequences of the individuals. Each action and its corresponding working context can be inserted into the working knowledge context graph 240 as entries. The expert avatar engine 112 or learning engine 110 may analyze the working context knowledge graph 240 and/or action sequences through various analytical techniques to assess the efficacy of performed action sequences. In some cases, the learning engine 110, for example, may determine that a different action sequence may be optimal as compared to the target actions captured for an expert. In such cases, the learning engine 110 may update the semantic actions database 230 with an updated target action sequence, e.g., as learned through analytical processes and optimization analyses. Any suitable form of feedback loops, knowledge gathering, analytical processing, optimization techniques, knowledge graph reasoning technologies, and the like are contemplated herein to continually update (e.g., improve or optimize) the semantic actions database 230, working context knowledge graph 240, or the virtual avatar itself.

In some implementations, the working context knowledge graph 240 may capture any relevant knowledge of the task, individuals performing the task, and variety of environments in which the task is performed, and the learning engine 110 may continually update the working context knowledge graph 240. Real-time context and performance data from individuals performing a task may be captured, analyzed, evaluated, and/or stored in the working context knowledge graph 240. Analyses may include any type of metric or evaluation of performed process steps, efficacy, efficiencies, KPIs, or any other form of measurement to assess how well the task was performed, which the learning engine 110 may capture into the working context knowledge graph 240. As such, the working context knowledge graph 240 may support the various expert-based guidance technologies presented herein.

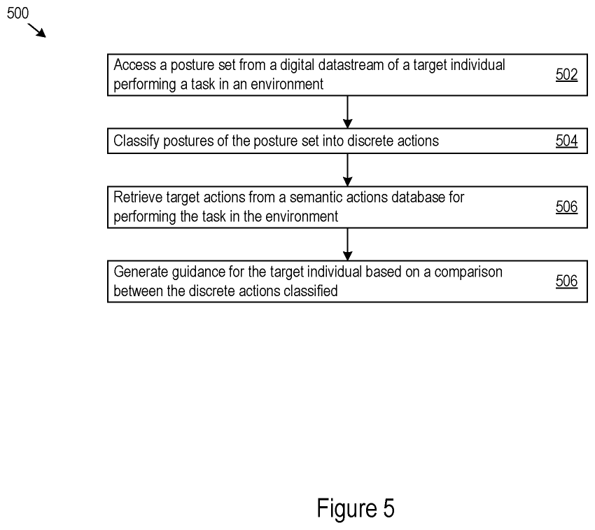

FIG. 5 shows an example of logic 500 that a system may implement to support expert-based guidance in AR and VR environments. For example, the computing system 100 may implement the logic 500 as hardware, executable instructions stored on a machine-readable medium, or as a combination of both. The computing system 100 may implement the logic 500 via the learning engine 110, the expert avatar engine 112, or a combination of both, through which the computing system 100 may perform or execute the logic 500 as a method to support provision of expert-based guidance according to the present disclosure. The following description of the logic 500 is provided using the expert avatar engine 112 as an example. However, various other implementation options by computing systems are possible.

In implementing the logic 500, the expert avatar engine 112 may access a posture set from a digital data stream of a target individual performing a task in an environment (502). As noted herein, postures of the posture set may be represented through joint locations of the target individual. The expert avatar engine 112 may further classify the postures of the posture set into discrete actions (504) and retrieve target actions from a semantic actions database for performing the task in the environment. Then, the expert avatar engine 112 may generate guidance for the target individual based on a comparison between the discrete actions classified for the target individual and the target actions retrieved from the semantic actions database (506) and provide the guidance to the target individual to assist the target individual in performing the task (508).

The logic 500 shown in FIG. 5 provides an illustrative example by which a computing system 100 may support expert-based guidance in AR and VR environments. Additional or alternative steps in the logic 500 are contemplated herein, including according to any of the various features described herein for the learning engine 110, the expert avatar engine 112, or any combinations thereof. For example, the method 500 may additionally or alternatively include any of the expert knowledge capture features described herein for the learning engine 110.

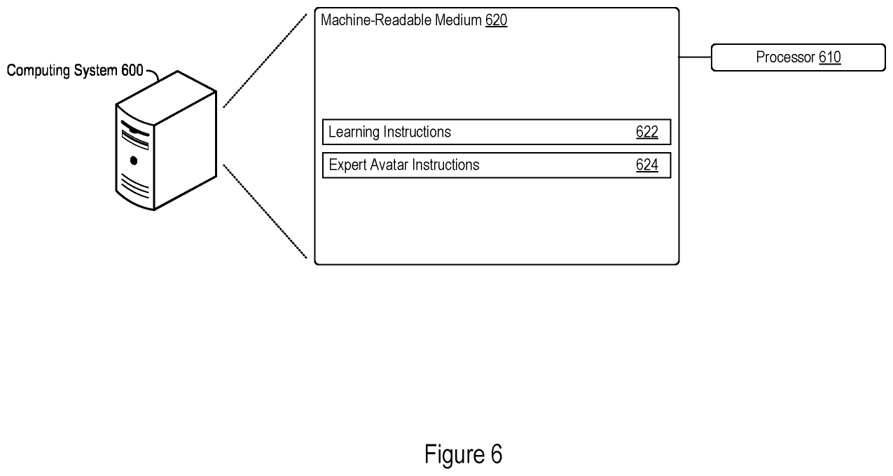

FIG. 6 shows an example of a computing system 600 that supports expert-based guidance in AR and VR environments. The computing system 600 may include a processor 610, which may take the form of a single or multiple processors. The processor(s) 610 may include a central processing unit (CPU), microprocessor, or any hardware device suitable for executing instructions stored on a machine-readable medium. The computing system 600 may include a machine-readable medium 620. The machine-readable medium 620 may take the form of any non-transitory electronic, magnetic, optical, or other physical storage device that stores executable instructions, such as the learning instructions 622 and the expert avatar instructions 624 shown in FIG. 6. As such, the machine-readable medium 620 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 600 may execute instructions stored on the machine-readable medium 620 through the processor 610. Executing the instructions (e.g., the learning instructions 622 and/or the expert avatar instructions 624) may cause the computing system 600 to perform any of the expert-based guidance features described herein, including according to any of the features of the learning engine 110, the expert avatar engine 112, or combinations of both.

For example, execution of the learning instructions 622 by the processor 610 may cause the computing system 600 to capture expert knowledge of an expert individual performing a given task, for example by determining a set of actions the expert individual to perform the task, storing the set of actions as target actions for the task in a semantics actions database, and inserting actions of the set of actions, environment conditions for the set of actions, or combinations of both as entries in the working context knowledge graph. As described herein, the semantic actions database may be configured to reference a working context knowledge graph to specify the target actions based on the task and environment conditions of the environment in which an individual (e.g., the expert or an AR or VR user) performs the task.

Execution of the expert avatar instructions 624 by the processor 610 may cause the computing system 600 to access a posture set from a digital data stream of a target individual performing a task in an environment, classify the postures of the posture set into discrete actions, retrieve target actions from a semantic actions database for performing the task in the environment, and generate guidance for the target individual based on a comparison between the discrete actions classified for the target individual and the target actions retrieved from the semantic actions database. Execution of the expert avatar instructions 624 by the processor 610 may further cause the computing system 600 to provide the guidance to the target individual to assist the target individual in performing the task, for example in the form of a virtual 3D avatar rendered in an AR or VR environment, doing so in any of the ways described herein.

Any additional or alternative expert-based guidance features as described herein may be implemented via the learning instructions 622, expert avatar instructions 624, or a combination of both.

The systems, methods, devices, and logic described above, including the learning engine 110 and the expert avatar engine 112, may be implemented in many different ways in many different combinations of hardware, logic, circuitry, and executable instructions stored on a machine-readable medium. For example, the learning engine 110, the expert avatar engine 112, or combinations thereof, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the learning engine 110, the expert avatar engine 112, or combinations thereof.

The processing capability of the systems, devices, and engines described herein, including the learning engine 110 and the expert avatar engine 112, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
by a computing system:
accessing a posture set from a digital data stream of a target individual performing a task in an environment, wherein postures of the posture set are represented through joint locations of the target individual;
classifying the postures of the posture set into discrete actions;
retrieving target actions from a semantic actions database for performing the task in the environment, wherein the semantic actions database is configured to reference a working context knowledge graph to specify the target actions based on the task and environment conditions of the environment in which the target individual performs the task;
generating guidance for the target individual based on a comparison between the discrete actions classified for the target individual and the target actions retrieved from the semantic actions database; and
providing the guidance to the target individual to assist the target individual in performing the task.

2. The method of claim 1, wherein the environment comprises a physical environment, and
wherein the posture set is determined from a video stream of the target individual performing the task in the physical environment; and
comprising providing the guidance through an augmented reality (AR) device used by the target individual or another individual in the physical environment.

3. The method of claim 1, wherein the environment comprises a virtual reality environment and wherein the target individual comprises a user avatar in the virtual reality environment, and
wherein the posture set is determined from the user avatar performing the task in the virtual environment; and
comprising providing the guidance through a virtual avatar in the virtual reality environment.

4. The method of claim 1, further comprising capturing expert knowledge to store in the semantic actions database, the working context knowledge graph, or a combination of both, including by:
determining a set of actions of an expert individual to perform the task;
storing the set of actions as the target actions for the task in the semantics actions database; and
inserting actions of the set of actions, environment conditions for the set of actions, or combinations of both as entries in the working context knowledge graph.

5. The method of claim 4, wherein determining the set of actions of the expert individual to perform the task comprises exporting an instruction set from an engineering tool.

6. The method of claim 4, wherein determining the set of actions of the expert to perform the task comprises:
accessing an expert posture set from a digital data stream of the expert individual performing the task, wherein postures of the expert posture set are represented through joint locations of the expert; and
classifying the postures of the expert posture set into discrete actions to form the set of actions of the expert individual.

7. The method of claim 1, further comprising updating the working context knowledge graph or the semantics action database based on analytical processes performed to analyze working context data stored in the working context knowledge graph.

8. A system comprising:
a semantic actions database configured to reference a working context knowledge graph to specify target actions to perform a task and environment conditions of an environment in which an individual performs the task;
a processor; and
a non-transitory machine-readable medium comprising instructions that, when executed by the processor, cause a computing system to:
access a posture set from a digital data stream of a target individual performing the task in an environment, wherein postures of the posture set are represented through joint locations of the target individual;
classify the postures of the posture set into discrete actions;
retrieve target actions from the semantic actions database for performing the task in the environment;
generate guidance for the target individual based on a comparison between the discrete actions classified for the target individual and the target actions retrieved from the semantic actions database; and
provide the guidance to the target individual to assist the target individual in performing the task.

9. The system of claim 8, wherein the environment comprises a physical environment, and
wherein the posture set is determined from a video stream of the target individual performing the task in the physical environment; and
wherein the instructions cause the computing system to provide the guidance through an augmented reality (AR) device used by the target individual or another individual in the physical environment.

10. The system of claim 8, wherein the environment comprises a virtual reality environment and wherein the target individual comprises a user avatar in the virtual reality environment, and
wherein the posture set is determined from the user avatar performing the task in the virtual environment; and
wherein the instructions cause the computing system to provide the guidance through a virtual avatar in the virtual reality environment.

11. The system of claim 8, wherein the instructions, when executed, further cause the computing system to capture expert knowledge to store in the semantic actions database, the working context knowledge graph, or a combination of both, including by:
determining a set of actions of an expert individual to perform the task;
storing the set of actions as the target actions for the task in the semantics actions database; and
inserting actions of the set of actions, environment conditions for the set of actions, or combinations of both as entries in the working context knowledge graph.

12. The system of claim 11, wherein the instructions, when executed, cause the computing system to determine the set of actions of the expert individual to perform the task by exporting an instruction set from an engineering tool.

13. The system of claim 11, wherein the instructions, when executed, cause the computing system to determine the set of actions of the expert to perform the task by:
accessing an expert posture set from a digital data stream of the expert individual performing the task, wherein postures of the expert posture set are represented through joint locations of the expert; and
classifying the postures of the expert posture set into discrete actions to form the set of actions of the expert individual.

14. The system of claim 8, wherein the expert avatar engine is further configured to update the working context knowledge graph or the semantics action database based on analytical processes performed to analyze working context data stored in the working context knowledge graph.

15. A non-transitory machine-readable medium comprising instructions that, when executed by a processor, cause a computing system to:
access a posture set from a digital data stream of a target individual performing the task in an environment, wherein postures of the posture set are represented through joint locations of the target individual;
classify the postures of the posture set into discrete actions;
retrieve target actions from the semantic actions database for performing the task in the environment;
generate guidance for the target individual based on a comparison between the discrete actions classified for the target individual and the target actions retrieved from the semantic actions database; and
provide the guidance to the target individual to assist the target individual in performing the task.

16. The non-transitory machine-readable medium of claim 15, wherein the environment comprises a physical environment, and
wherein the posture set is determined from a video stream of the target individual performing the task in the physical environment; and
wherein the instructions cause the computing system to provide the guidance through an augmented reality (AR) device used by the target individual or another individual in the physical environment.

17. The non-transitory machine-readable medium of claim 15, wherein the environment comprises a virtual reality environment and wherein the target individual comprises a user avatar in the virtual reality environment, and
wherein the posture set is determined from the user avatar performing the task in the virtual environment; and
wherein the instructions cause the computing system to provide the guidance through a virtual avatar in the virtual reality environment.

18. The non-transitory machine-readable medium of claim 15, wherein the instructions, when executed, further cause the computing system to capture expert knowledge to store in the semantic actions database, the working context knowledge graph, or a combination of both, including by:
determining a set of actions of an expert individual to perform the task;
storing the set of actions as the target actions for the task in the semantics actions database; and
inserting actions of the set of actions, environment conditions for the set of actions, or combinations of both as entries in the working context knowledge graph.

19. The non-transitory machine-readable medium of claim 18, wherein the instructions, when executed, cause the computing system to determine the set of actions of the expert individual to perform the task by exporting an instruction set from an engineering tool.

20. The non-transitory machine-readable medium of claim 18, wherein the instructions, when executed, cause the computing system to determine the set of actions of the expert to perform the task by:
accessing an expert posture set from a digital data stream of the expert individual performing the task, wherein postures of the expert posture set are represented through joint locations of the expert; and
classifying the postures of the expert posture set into discrete actions to form the set of actions of the expert individual.
